(19) United States
(12) Patent Application Publication
(10) Pub. No.: US 2026/0107979 A1
(43) Pub. Date: Apr. 23, 2026

(54) Consumable with Liquid Aerosol-Forming Substrate Pre-Heating

(71) Applicant: JT International SA, Geneva (CH)

(72) Inventors: Alec Wright, Guildford (GB); Miguel Soriano, Geneva (CH); Simeon Williamson, Versoix (CH)

(73) Assignee: JT International SA, Geneva (CH)

(21) Appl. No.: 19/117,726

(22) PCT Filed: Oct. 30, 2023
(86) PCT No.: PCT/EP2023/080194

§ 371 Date: Apr. 2, 2025

(30) Foreign Application Priority Data
Oct. 31, 2022 (EP) 22204655.9

(51) Int. Cl. A24F 40/42; A24F 40/10; A24F 40/44; A24F 40/46; A24F 40/465; A24F 40/48; H05B 3/06; H05B 6/10

(52) U.S. Cl. CPC A24F 40/42; A24F 40/10; A24F 40/44; A24F 40/46; A24F 40/465; A24F 40/48; H05B 3/06; H05B 6/108; H05B 2203/021

(57) ABSTRACT

A consumable for use with an aerosol generation device. The consumable may include a heating element for use with viscous liquid aerosol-forming substrates. The consumable may include an aerosol outlet path, a reservoir comprising a liquid aerosol-forming substrate, and a heating element. The reservoir may have an upper domain and a lower domain, the upper domain and the lower domain being in fluid connection with each other, the lower domain defining an opening to the outlet path. The heating element may include a lower part arranged at the opening of the lower domain and an upper part extending within the upper domain. The heating element may extend along the aerosol outlet path.

### FIELD OF INVENTION

The present invention relates to a consumable for use with an aerosol generation device, in particular a consumable with a heating element for use with viscous liquid aerosol-forming substrates.

### TECHNICAL BACKGROUND

Aerosol generation devices presently on the market can generate an aerosol from a liquid aerosol-forming substrate. These liquid substrates typically comprise a mixture of propylene glycol (PG), vegetable glycerine (VG), flavorings, and nicotine.

Alternatively, such liquid substrate comprising nicotine can be provided as a tobacco liquid (T-liquid) which comprises PG, VG and ground tobacco suspended within the liquid. The nicotine present into the liquid then essentially originates from natural tobacco materials.

However, the suspended ground tobacco becomes problematic when used with aerosol generation devices that employ a common wick and coil heating element. The suspended ground tobacco renders the liquid substrate more viscous, and the wick can quickly become clogged with the suspended ground tobacco. Both factors reduce the wicking capability of the wick and thus reduce overall performance of the aerosol generation device.

Therefore, there is a need for a consumable that prevents the negative effects of such viscous aerosol-forming substrates for an improved performance of the aerosol generation device.

### SUMMARY OF THE INVENTION

Some, or all of the above objectives are achieved by the invention as defined by the features of the independent claims. Preferred embodiments of the invention are defined by the features of the dependent claims.

A 1^{st} aspect of the invention is a consumable for use with an aerosol generation device, the consumable comprising an aerosol outlet path, a reservoir comprising a liquid aerosol-forming substrate, and a heating element. The reservoir has an upper domain and a lower domain, the upper domain and the lower domain being in fluid connection with each other, the lower domain defining an opening to the outlet path. The heating element comprises a lower part arranged at the opening of the lower domain and an upper part extending within the upper domain. The heating element further extends along the aerosol outlet path.

With the arrangement of the 1^{st} aspect, the liquid aerosol-forming substrate in the upper domain of the reservoir can be pre-heated and aerosol can be generated within the outlet path near the lower domain of the reservoir, at the same time and using the same heating element. This is particularly advantageous in cases where the aerosol-forming substrate is viscous because the pre-heating reduces the viscosity and furthers the flow of the substrate. The heating element extending along the aerosol outlet path increases the surface area of the heating element to generate an aerosol. This means that the longitudinal direction of the upper part of the heating element is substantially parallel to the flow direction of the outlet path. The arrangement of the present invention improves the aerosol generation performance of the consumable.

According to a 2^{nd} aspect, in the preceding aspect, the upper part and the lower part of the heating element are integrally formed.

An integrally formed heating element does not require joining the upper and lower part of the heating element. It reduces manufacturing costs and complexities, and allows for further miniaturization of the heating element to make better use of the typically constrained space within the consumable.

According to a 3^{rd} aspect, in the preceding aspect, the upper part of the heating element is arranged within the volume of the upper domain enclosed by reservoir walls such that it is surrounded by the liquid aerosol-forming substrate.

The 3^{rd} aspect leads to more uniform and thus improved heating of a liquid aerosol-forming substrate that can be contained in the upper part of the reservoir.

According to a 4^{th} aspect, in any one of the preceding aspects, the lower part of the heating element is configured to wick the liquid aerosol-forming substrate.

The 4^{th} aspect eliminates the need for a separate, dedicated wicking element. This reduces manufacturing complexities and the space requirements within the consumable.

According to a 5^{th} aspect, in any one of the preceding aspects, the lower part of the heating element is configured to heat the liquid aerosol-forming substrate to a first temperature suitable for generating an aerosol.

Thus, the heating element can be used to generate an aerosol at the opening of the reservoir to the outlet path.

According to a 6^{th} aspect, in the preceding aspect, the first temperature is at least 190° C., preferably at least 200° C., more preferably at least 210° C., most preferably at least 220° C., and/or the first temperature is at most 340° C., preferably at most 330° C., more preferably at most 320° C., most preferably at most 310° C.

The specified temperature ranges allow typical liquid aerosol-forming substrates to turn into an aerosol without burning the substrates.

According to a 7^{th} aspect, in any one of the preceding aspects, the upper part of the heating element is configured to heat liquid aerosol-forming substrate comprised in the upper domain of the reservoir to a second temperature not suitable for generating an aerosol.

Thus, some or all of the liquid aerosol-forming substrate in the upper domain of the reservoir can be heated up without generating an aerosol, to reduce the viscosity of the liquid aerosol-forming substrate. This facilitates wicking of the liquid aerosol-forming substrate and thus improves the heating performance of the consumable.

According to an 8^{th} aspect, in the preceding aspect, the second temperature is at least 15° C., preferably at least 20° C., more preferably at least 25° C., most preferably at least 30° C., and/or the second temperature is at most 60° C., preferably at most 55° C., more preferably at most 50° C., most preferably at most 45° C.

The specified temperature ranges allow typical liquid aerosol-forming substrates to be heated for reducing their viscosities without generating an aerosol in the reservoir.

According to a 9^{th} aspect, in any one of the preceding aspects, the surface area of the upper part of the heating element makes up at least 10%, preferably at least 15%, more preferably at least 20%, most preferably at least 25% of the surface area of the heating element, and/or the surface area of the lower part makes up less than 50%, preferably less than 45%, more preferably less than 40%, most preferably less than 35% of the surface area of the heating element.

According to a 10^{th} aspect, in any one of the preceding aspects, the upper part of the heating element extends at least 0.5 cm, preferably at least 0.75 cm, more preferably at least 1.0 cm, and most preferably at least 1.25 cm within the upper domain of the reservoir.

The 9^{th} and 10^{th} aspects provide an optimized area of contact between the upper part of the heating element and the liquid aerosol-forming substrate in the reservoir, to optimize heating up the liquid aerosol-forming substrate while preventing overheating of the aerosol-forming substrate by the lower part of the heating element.

According to an 11^{th} aspect, in any one of the preceding aspects, the lower part of the heating element is permeable to the liquid aerosol-forming substrate.

This improves the aerosol generation performance of the heating element by allowing the aerosol-forming substrate to permeate from the opening of the lower domain through the lower part of the heating element to the outlet path.

According to a 12^{th} aspect, in any one of the preceding aspects, at least a portion of the lower part of the heating element is perforated.

The perforation reduces the effects of clogging caused by larger particles and particulates suspended in the liquid aerosol-forming substrate.

According to a 13^{th} aspect, in any one of the preceding aspects, at least 50%, preferably at least 60%, even more preferably at least 70%, and most preferably at least 80% of the volume of the reservoir is arranged in the upper domain of the reservoir.

This allows to limit the volume of the substrate which is heated to a higher temperature in the lower domain, and thereby saves energy.

According to a 14^{th} aspect, in any one of the preceding aspects, the lower part of the heating element is an active heater configured to be heated by direct or undirect interaction with an electrical current, and the upper part of the heating element is a passive heater configured to be heated by heat transferred from the lower part of the heating element.

This provides a configuration that allows the lower part of the heating element to heat an aerosol generation substrate to a temperature that is higher than the temperature to which an aerosol generation substrate is heated by the upper part of the heating element.

According to a 15^{th} aspect, in any one of the preceding aspects, the heating element is a susceptor element.

A susceptor element does not require physical contact with a power source to heat up. This provides greater constructional flexibility and reduces wear and tear due to a lack of physical contacts to the power source.

According to a 16^{th} aspect, in any one of the preceding aspects, the consumable further comprises a wicking element in contact with and arranged for directly wicking the liquid aerosol-forming substrate from the lower domain of the reservoir to the heating element.

A dedicated wicking element can provide an optimized wicking performance for a wide range of liquid aerosol-forming substrates.

According to a 17^{th} aspect, in the preceding aspect, the wicking element surrounds at least the outer surface(s) of the heating element which is/are substantially parallel to the flow direction of the outlet path.

Thus, any liquid coming in contact with the heating element passes through the wicking element. In comparison to known wick and coil heating arrangements, the 16^{th} aspect increases the surface of the wicking element and thus reduces the negative effects of clogging caused by particles and particulates suspended in the liquid aerosol-forming substrate.

According to an 18^{th} aspect, in any one of the preceding aspects, the liquid aerosol-forming-substrate comprises a tobacco suspension.

According to a 19^{th} aspect, in any one of the preceding aspects, the upper domain of the reservoir is divided into a first part and a second part arranged on two opposing sides of the aerosol outlet path such that the two parts are not in direct fluid connection within the upper domain.

The separation into two parts avoids the formation of narrow passages in upper domain of the reservoir. Narrow passages in the upper domain negatively affect the flow of liquid aerosol-forming substrate in the upper domain to the lower domain of the reservoir and thus reduce the supply of liquid aerosol-forming substrate to the heating element.

A 20^{th} aspect of the invention is directed to an aerosol generation device for use with a consumable according to any one of the preceding aspects, the aerosol generation device comprising means for receiving the consumable, and means for supplying energy to the heating element.

The 20^{th} aspect is an aerosol generation device which makes use of the advantages of a consumable according to any one of the 1^{st} to 19^{th} aspects of the invention.

According to a 21^{st} aspect, in the preceding aspect, the means for receiving the consumable is a cavity or receptacle.

The 21^{st} aspect allows a consumable to be securely received by the aerosol generation device.

According to a 22^{nd} aspect, in any one of 20^{th} to 21^{st} aspects, the receiving means of the aerosol generation device is configured to receive at least the portion of the consumable which comprises the lower part of the heating element.

The 22^{nd} aspect brings the lower part of the heating element that is to be heated into proximity of the aerosol generation device. This simplifies the provision of means for controlling heating of the heating element.

According to a 23^{rd} aspect, in any one of the 20^{th} to 22^{nd} aspects, the means for supplying energy is an inductor configured to apply a changing electromagnetic field to the lower part of the heating element of the consumable when it is received by the aerosol generation device.

The 23^{rd} aspect provides a reliable and non-contact means of actively heating the lower part of the heating element, but preferably not the upper part of the heating element.

According to a 24^{th} aspect, in the preceding aspect, the inductor is configured to surround at least a portion or all of the lower part of the heating element when the consumable is received by the aerosol generation device.

The 24^{th} aspect ensures improved heating of the heating element via the inductor.

A 25^{th} aspect of the invention is an aerosol generation system comprising a consumable according to any one of the 1^{st} to 19^{th} aspects, and an aerosol generation device according to any one of the 20^{th} to 24^{th} aspects.

### BRIEF DESCRIPTION OF THE DRAWINGS

FIG. 1 shows a schematic illustration of a cross-sectional side-view of a consumable according to embodiments of the invention;

FIGS. 2A and 2B show schematic illustrations of a cross-sectional top-view of the consumable through layer A as shown in FIG. 1, according to embodiments of the invention;

FIG. 3 shows a schematic illustration of a cross-sectional side-view of the consumable in use with an aerosol generation device, according to embodiments of the invention.

### DETAILED DESCRIPTION OF PREFERRED EMBODIMENTS

Preferred embodiments are now described, by way of example only, with reference to the accompanying drawings.

In the description of the present invention, it should be understood that the terms “one end”, “the other end”, “outer side”, “upper”, “above”, “inner side”, “under”, “below”, “horizontal”, “coaxial”, “central”, “end part”, “outer end” etc., which indicate an orientation or positional relationship, are based on the orientation or positional relationship shown in the drawings. The terms such as “upper”, “above”, “below”, “under” and the like used in the present invention to indicate a relative position in space are used for the purpose of facilitating explanation to describe a unit or feature shown in the drawings relative to the relationship of another unit or feature. The term of the relative position in space may be intended to include different orientations of the device in use or operation other than those shown in the figures. For example, if the device in the figure is turned over, the unit described as being “below” or “under” other units or features will be “above” the other units or features. Therefore, the exemplary term “below” can encompass both the above and below orientations. The device can be oriented in other ways (rotated by 90 degrees or other orientations), and the space-related descriptors used herein are explained accordingly. More specifically, the word “above” means that one unit, layer or element is arranged or configured relatively in an exterior direction of the device towards the (an)other unit(s), layer(s), or element(s); the word “below” means that one unit, layer or element is arranged or configured relatively in an interior direction of the device towards the other units, layers, or elements.

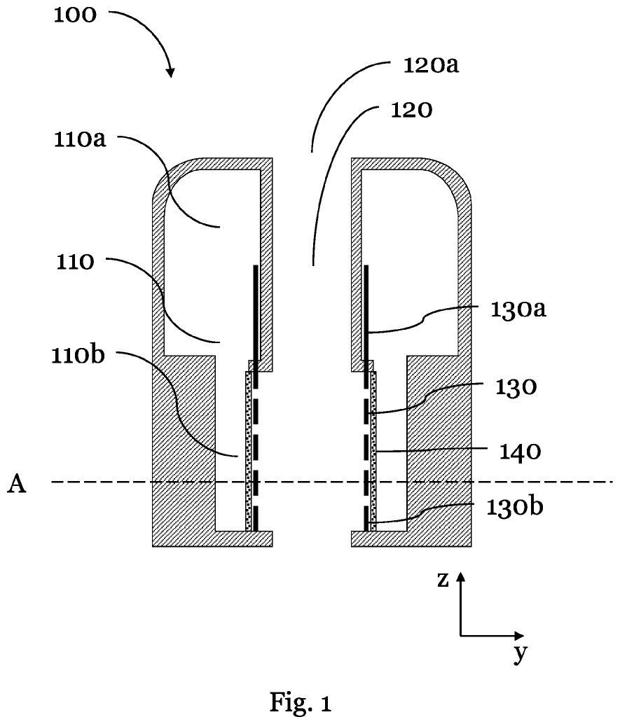

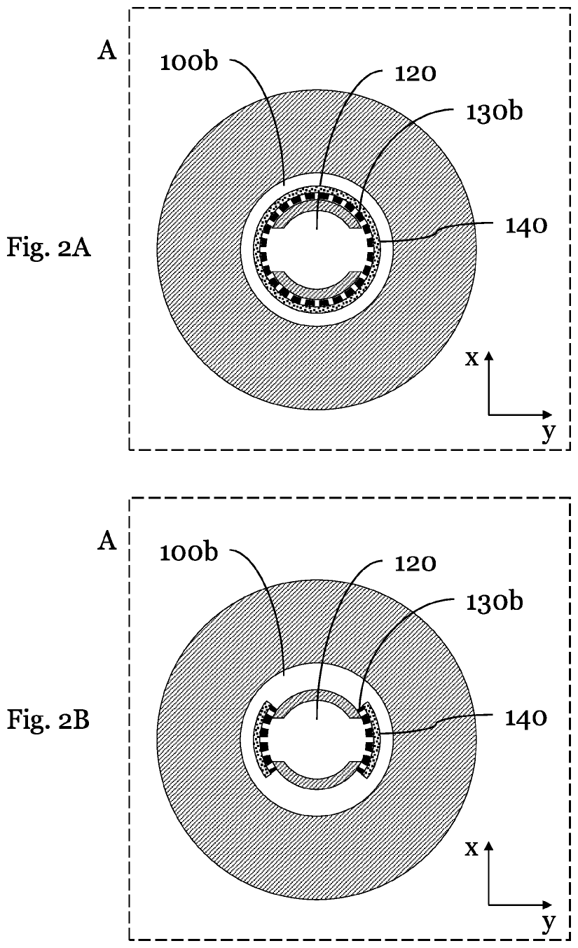

FIG. 1 shows a consumable 100 according to embodiments of the present invention. As shown, the consumable comprises a liquid reservoir 110 for containing an aerosol-forming substrate, such as a liquid aerosol-forming substrate. The liquid aerosol-forming substrate is preferably a T-liquid that comprises a tobacco material such as, for example, ground tobacco, suspended in the liquid. Depending on the shape of the consumable, the reservoir 110 may have a corresponding shape. For example, if the consumable has a circular cross-section in top-view, as will be described below in conjunction with FIGS. 2A and 2B, the reservoir may have a cylindrical or tubular shape. The consumable is further provided with an aerosol outlet path 120. According to other embodiments, the consumable and consequently the reservoir 110 may also have an elliptical cross-section. The outlet path 120 may be positioned in the center, in top-view, of the consumable 100, and extends in the up-down z-direction in FIG. 1. The aerosol outlet path 120 forms a path from an area where aerosol can be generated for consumption by a user, to an outlet opening 120a. In the downstream direction, the outlet opening 120a may lead to or may be a mouthpiece through which a user may consume a generated aerosol. In the upstream direction, one or more inlet openings (not shown) may be provided to allow air to enter the outlet path 120.

To make efficient use of the space in the consumable 100, the reservoir 110 may extend along the extension direction of the outlet path, preferably in the z-direction as shown in FIG. 1, and may also extend along all or most of the extension direction of the outlet path 120, taking into account wall thicknesses required for providing a reservoir 110. The reservoir 110 comprises or consists of an upper domain 110a that is arranged near an upper end of the consumable 100 in the z-direction, where the outlet opening 120a is provided, and a lower domain 110b near a lower end of the consumable 100 in the z-direction. The upper domain 110a preferably includes the largest part of the volume of the reservoir 110, while the lower domain 110b serves to provide liquid communication from the upper domain 110a to a heating element 130 positioned at an opening of the lower domain 110b that leads to the outlet path 120. For this purpose, the volume of the upper domain 110a may make up more than 50%, preferably more than 60%, even more preferably 70%, most preferably 80% of the total volume of the reservoir 110.

Consequently, the remaining percentage of the volume of the reservoir 110 is substantially allocated to the lower domain 110b.

At the opening of the lower domain 110b that leads to the outlet path 120, a heating element 130 is provided such that liquid leaving the reservoir 110 via the opening of the lower domain 110b can be heated by the heating element 130 for generating an aerosol that can subsequently be discharged through the outlet opening 120a for consumption by a user. The heating element 130 comprises a lower part 130b and an upper part 130a. The lower part 130b is positioned at the opening of the lower domain 110b of the reservoir such that liquid exiting the reservoir 110 through that opening can be heated by the lower part 130b to generate an aerosol. The lower part 130b being arranged at the opening preferably means that any liquid leaving the lower domain 110b of the reservoir must pass through the lower part 130b of the heating element. This prevents unintended leakage of the liquid out of the reservoir. The heating element 130a further comprises an upper part 130a that is arranged within the upper domain 110a of the liquid reservoir 110 such that the liquid aerosol-forming substrate in the reservoir 110 can be heated by the upper part 130a. In contrast to commonly employed wick and coil heaters, in which a wick typically extends in the left-right y-direction and a heating coil is wound or wrapped around the wick, the heating element 130 of the present invention extends in the up-down z-direction. Unlike in the commonly employed wick and coil configuration, the surface area of the heating element 130 that can heat and generate an aerosol is thus increased. As an additional advantage, the distance between the opening of the lower domain 110b and the heating element 130 is reduced, as the liquid aerosol-forming substrate does not need to travel through the longitudinal extension of the wick in the y-direction of the common wick and coil configuration. Consequently, issues with clogging due to particles or particulates such as, e.g., tobacco, that are suspended in the liquid aerosol-forming substrate can be reduced. In combination with the higher surface area for generating an aerosol, the heating performance of the heating element 130 can be improved.

In one embodiment, a dedicated wicking element 140 is provided to draw liquid from the opening of the lower domain 110b of the reservoir 110. The wicking element 140 is preferably arranged on the outside, in top-view, of the lower part 130b of the heating element 130, and preferably surrounds the lower part 130b of the heating element 130 on its outer lateral surface. In this way, any liquid heated by the lower part 130b of the heating element 130 is first drawn into the wicking element 140. This ensures a steady supply of liquid aerosol-forming substrate from the lower domain 110b of the reservoir 110 to the lower part 130b of the heating element 130, and can further prevent uncontrolled leakage of the liquid aerosol-forming substrate from the reservoir. The wicking element 140 preferably comprises or consists of a fibrous material such as cotton, or a porous ceramic material. It can be formed using several layers of such a material.

The lower part 130b of the heating element 130 may be permeable to the aerosol-forming substrate. This aids in transporting the aerosol-forming substrate from the wicking element 140 through the lower part 130b of the heating element 130 to the outlet path 120 for generating an aerosol for user consumption. For this purpose, the lower part 130b of the heating element 130 may be porous and/or provided with perforations. To inhibit or reduce negative effects of clogging that may occur when used with a T-liquid, the average perforation size is preferably between 0.3 mm to 0.7 mm, more preferably between 0.4 mm and 0.6 mm, most preferably 0.5 mm. The density and/or size of perforations can further be adequately chosen based on the desired overall permeability of the heating element 130.

In addition to, or as an alternative to the wicking element 140, the lower part 130b of the heating element 130 may itself be configured to wick the liquid aerosol-forming substrate from the lower domain 110b of the reservoir 110. This may be achieved by an appropriate porosity and/or appropriate perforations of the lower part of the heating element. By providing a lower part 130b of the heating element 130 that can wick the liquid aerosol-forming substrate, a dedicated wicking element 140 can be foregone. This reduces material and space requirements in the consumable 100 and reduces the manufacturing complexity.

The lower part 130b of the heating element is preferably configured for heating the liquid aerosol-forming substrate, either drawn into the wicking element 140, or drawn by the lower part 130b itself, to a first temperature that is high enough for generating an aerosol from the liquid aerosol-forming substrate. Depending on the aerosol-forming substrate, the first temperature may be is at least 190° C., preferably at least 200° C., more preferably at least 210° C., most preferably at least 220° C. Additionally, or alternatively, to prevent burning and releasing unwanted substances, the first temperature may be at most 340° C., preferably at most 330° C., more preferably at most 320° C., most preferably at most 310° C.

The upper part 130a of the heating element 130 is positioned within the upper domain 110a of the reservoir 110 that preferably provides most of the volume of the reservoir 110. As with the lower part 130b, the upper part 130a of the heating element extends in the extension direction (flow direction) of the outlet path 120 in the up-down z-direction as indicated in FIG. 1. This means that the longitudinal direction of the upper part 130a of the heating element is substantially parallel to the flow direction of the outlet path. The upper part 130a is preferably positioned within the enclosed volume of the reservoir 110 and spaced away from any enclosure walls of the reservoir 110 such that it is surrounded by liquid when the reservoir is filled, at least on lateral sides, and preferably also on the top side. This affords a more uniform and improved heating of the liquid aerosol-forming substrate contained in the upper domain 110a. The upper part 130a of the heating element 130 is preferably not provided with any perforations through which the liquid aerosol-forming substrate may permeate. Additionally, the upper part 130a of the heating element 130 is preferably configured to heat the liquid aerosol-forming substrate contained in the upper domain 110a of the reservoir to a second temperature that is below the first temperature and that is not sufficiently high for generating an aerosol. The second temperature may be at least 15° C., preferably at least 20° C., more preferably at least 25° C., most preferably at least 30° C. Additionally, or alternatively, the second temperature may be at most 60° C., preferably at most 55° C., more preferably at most 50° C., most preferably at most 45° C.

While no aerosol is generated by the upper part 130a of the heating element 130, the heating performed by the upper part 130a serves to increase the temperature of the liquid aerosol-forming substrate contained in the upper domain 110a such that the viscosity of the liquid aerosol-forming substrate is reduced, without vaporizing it. This is advantageous as the viscosity of the liquid aerosol-forming substrate at room temperature may in particular be increased by particles and particulates such tobacco suspended in the liquid aerosol-forming substrate. As discussed, a higher viscosity of the aerosol-forming substrates negatively affects the aerosol generation performance of the consumable 100. Reducing the viscosity thus improves the flow of the liquid aerosol-forming substrate from the upper domain 110a, via the lower domain 110b through the opening to the heating element 130 for generating aerosol, thus improving the aerosol generation performance.

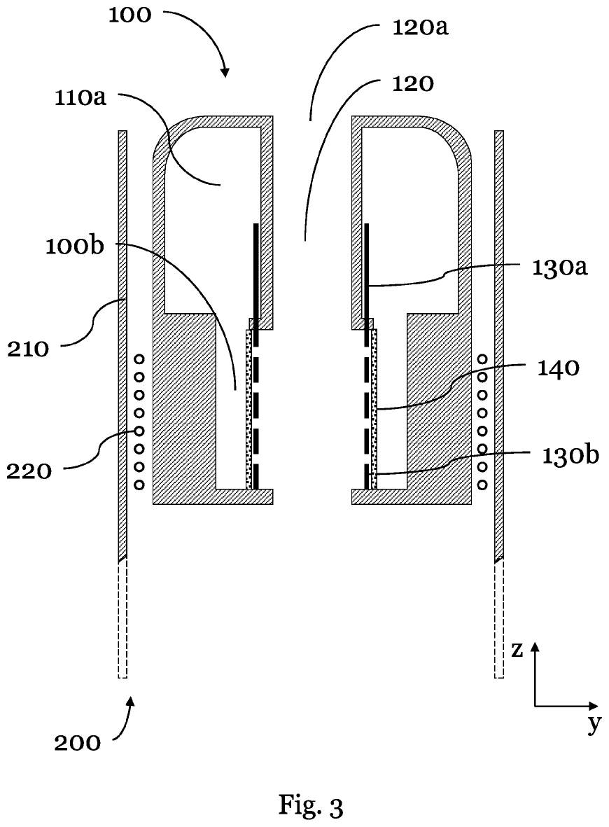

The upper part 130a of the heating element is thus preferably configured to merely heat up the liquid aerosol-forming substrate to a second temperature which reduces its viscosity without generating an aerosol, while the lower part 130b of the heating element is preferably configured to heat up the liquid aerosol-forming substrate drawn from the reservoir 110 to a first temperature above the second temperature, to generate an aerosol. The difference in heating performance can be achieved in different ways. If the heating element is of a resistive heater type, electrical contacts may be provided such that an electrical current is only applied through the lower part 130b of the heating element 130 to actively heat only the lower part 130a. Thus, the upper part 130a is not actively heated. However, heat generated in the lower part 130b is transferred through the heating element 130 to the upper part 130a. Naturally, this leads to the upper part 130a being heated to a lower temperature than the lower part 130b. In a preferred embodiment, the heating element 130 is a susceptor element that generates heat when subjected to a magnetic field. Such a susceptor element is preferably made from a metallic material that may comprise or substantially consist of, for example, stainless steel 430 or carbon steel grade 1006. In order to heat the lower part 130b to a higher temperature than the upper part 130a, magnetic coils may be provided such that a magnetic field is substantially only applied to the lower part 130b of the heating element 130, but not to the upper part. This will further be described in the context of embodiments shown in FIG. 3 below.

As the upper part 130a of the heating element 130 is preferably not actively heated, sufficient heat transfer from the actively heated lower part 130b to the upper part 130a should be provided to adequately heat up the liquid aerosol-forming substrate in the upper domain 110a to reduce its viscosity. To achieve this, at least 10%, preferably at least 15%, more preferably at least 20%, most preferably at least 25% of the surface area of the entire heating element may be provided by the upper part 130a of the heating element. At the same time, it is preferable to avoid overheating of the liquid aerosol-forming substrate heated by the upper part 130a of the heating element. To achieve this, less than 50%, preferably less than 45%, more preferably less than 40%, most preferably less than 35% of the total surface area of the heating element 130 is provided by the lower part 130b of the heating element. Additionally, the lower part 130a and the upper part 130b can be connected using commonly known and suitable techniques. Alternatively, the lower part 130a and the upper part 130b may be integrally formed as a single piece. This reduces manufacturing complexities and further allows for a more optimized use of space within the limiting spatial constraints of the consumable, since using connecting elements to connect a separate lower part 130b and a separate upper part 130a of the heating element requires a certain amount of space and material.

Additionally, the lower part 130b and the upper part 130a may be of a same and uniform shape, such as, e.g., a single, thin, and curved plate-like shape, or a tubular shape.

FIGS. 2A and 2B show schematic illustrations of a cross-sectional top-view of layer A indicated by the dashed line marked with the letter “A” in FIG. 1, according to embodiments of the invention. In the schematic illustrations, cross-sectional top-views of the lower domain 110b of the reservoir 110 with the wicking element 140 and the lower part 130b of the heating element 130, according to embodiments of the invention, are shown. Although the consumable 100 is shown to have a circular base-shape and thus in general to have a cylindrical or tubular shape, any appropriate base shape can be chosen for the consumable 100. Accordingly, for an efficient use of space, both the upper domain 110a and the lower domain 110b of the liquid reservoir 110 may also have a corresponding circular or other suitable base shape. As also shown in FIG. 1, the upper domain 110a may have a larger radius or other appropriate size measurement than the lower domain 110b. The wicking element 140 and the lower part 130b of the heating element 130 are arranged at the opening of the lower domain 110b that leads to the outlet path 120.

Due to a typically circular or elliptical base shape of the consumable, the outlet path 120 may equally be provided with a circular or elliptical base shape, although any suitable shape may be used. In case of a circular or elliptical base shape, it is advantageous to provide the wicking element 140 and the lower part 130b of the heating element 130 with a corresponding curved or partial circular shape. In this way, any liquid aerosol-forming substrate leaving the lower domain 110b enters the wicking element 140, or the lower part 130b of the heating element if no wicking element 140 is provided. This ensures optimal wicking of the liquid aerosol-forming substrate to optimize the generation of an aerosol and prevents uncontrolled leakage of the liquid aerosol-forming substrate from the reservoir 110. As can further be seen, in contrast to commonly employed wick and coil heater configurations, in which the wick would be arranged in the left-right y-direction across the outlet path, the distance that the liquid aerosol-forming substrate must travel through the wicking element 140 and the lower part 130b of the heating element is greatly reduced. This is especially advantageous as it reduces the negative effects of clogging in the wicking element 140 and/or the lower part 130b of the heating element due to the presence of particles or particulates such as tobacco suspended in the liquid aerosol-forming substrate.

In a preferred embodiment shown in FIG. 2A, the wicking element 140, and the lower part 130b or both the lower part 130b and the upper part 130a of the heating element, are formed to have a tubular, and more preferably a cylindrical shape, and have a circular, elliptical, or similar cross-section. In top-view, the wicking element 140 thus substantially surrounds the lower part 130b of the heating element. Additionally, or alternatively, as shown in FIG. 2B, the wicking element 140 and the lower part 130b of the heating element 130b may comprise or substantially consist of two separate parts for two openings of the lower domain 110b of the reservoir 110, although any suitable number of openings and thus parts of the wicking element 140 and lower part 130b of the heating element 130 may be provided. The wicking element 140, or each separate part of the wicking element 140, may comprise or substantially consist of one or more layers of cotton. In case of multiple layers of cotton, the layers may be stacked such that the stacking direction is from the lower domain towards the lower part 130b of the heating element. In a preferred embodiment, the density of the multiple cotton layers increases in the stacking direction. Particles and particulates such as a tobacco material can be caught in the less dense initial layer(s) while still allowing supply of liquid to the denser layers towards the heating element. In this way, negative effects of clogging by the suspended particles and particles can be mitigated or subdued.

FIG. 3 shows a schematic illustration of a cross-sectional side-view of a consumable 100 and a portion of an aerosol generation device 200 in use with each other and according to embodiments of the invention. The consumable 100 may in particular be a consumable 100 as described in the context of embodiments shown in FIGS. 1 and 2. The aerosol generation device 200 and the consumable are typically connected or joined to each other when in use. For this purpose, known connection means can be employed. In a preferred embodiment, the aerosol generation device 200 is provided with a reception means 210 such as a receptacle that can receive at least a portion of the consumable 100. Preferably, the reception means 210 surround or enclose, in top-view, at least the portion of the consumable 100 in which the lower part 130b of the heating element 130 is provided in the consumable 100.

In case the lower part 130b of the heating element is of a resistive heater type, this facilitates the provision of electrical contacts for heating the lower part 130b. In the embodiment shown in FIG. 3, in case the heating element 130 or at least the lower part 130b of the heating element 130 is a susceptor element, an inductor such as one more induction coils 220 may be arranged in or adjacent the reception means 210 to apply an electro-magnetic field to substantially only the lower part 130b of the heating element 130 to actively heat only the lower part 130b of the heating element via, e.g., Eddy currents flowing through the lower part 130b. Magnetic hysteresis can also be utilized for heating the lower part 130b. For this purpose, merely as an example, the one or more preferably helical induction coils 220 may be provided to surround, in top-view, the lower part 130b of the heating element, or to be on opposite sides of the lower part 130b of the heating element 130. At the same time, the one or more inductions coils 220 are not provided to surround or be on opposite sides of the upper part 130a of the heating element 130. This prevents the upper part 130a of the heating element 130 from being actively heated, and thus prevents the liquid aerosol-forming substrate in the upper domain 110a of the reservoir to be heated to such an extent that an aerosol is generated.

In general, the consumable 100 may have any appropriate shape required for use with a suitable aerosol generation device 200. As a non-limiting example, if the aerosol generation device 200 is provided with an elongated and optionally cylindrical shape, to imitate the look and feel of a traditional cigarette, the corresponding consumable 100 can also be provided with a cylindrical shape to provide a uniform outer appearance and smooth physical transition from the aerosol generation device 200 to the consumable 100 when connected or joined to each other. Not only does this improve the handling characteristics of the aerosol generation device 200 with the consumable 100, it also reduces the chance of unintended separation of the consumable 100 from the aerosol generation device 200. It is to be understood that the above can be applied to many different corresponding shapes of the aerosol generation device 200 and the consumable 100.

In another preferred embodiment, the upper domain 110a is divided into a first part and a second part that are arranged on two opposing sides of the outlet path 120 such that the two parts are not in direct fluid connection within the upper domain 110a. Such a configuration of the upper domain 110a is particularly advantageous when the consumable does not have a circular base-shape in top-view, but an elongated or elliptical base-shape to better conform to the shape of a user's mouth. In case of an elliptical base-shape, if the upper domain 110a is provided to surround the outlet path 120, in top-view, narrow passages where the distance between an inner wall and an outer wall, in top-view, of the upper domain 110a is smaller for portions of the upper domain 110a located near or along the minor axis, while, in contrast, the distance between the inner wall and the outer wall, in top-view, of the upper domain 110a is larger for portions of the upper domain 110a located near or along the major axis. Due to the smaller wall distance for portions near or along the minor axis, and due to an increased viscosity of a liquid aerosol-forming substrate containing suspended tobacco, flow of the liquid aerosol-forming substrate in portions of the upper domain 110a in the narrow passages near or along the minor axis is reduced, thus negatively affecting the aerosol generation performance of the consumable 100. By dividing the upper domain 110a into two parts that are not in direct fluid communication and arranging these parts on opposite sides of the outlet path 120, preferably along the major axis and not the minor axis, portions of the upper domain 110a with reduced flow of the liquid aerosol-forming substrate due to narrow passages with a smaller wall distance as detailed above can be prevented. Consequently, flow of the liquid aerosol-forming substrate in the upper domain 110a and to the lower domain 110b can be increased, and the overall aerosol generation performance of the consumable 100 can be improved.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure, as defined by the independent and dependent claims.

### LIST OF REFERENCE SIGNS USED

100: consumable
110: reservoir
110a: upper domain of reservoir
110b: lower domain of reservoir
120: outlet path
120a: outlet opening
130: heating element
130a upper part of heating element
130b lower part of heating element
140: wicking element
200: aerosol generation device
210: receptacle
220: induction coils

1. A consumable for use with an aerosol generation device, comprising:
an aerosol outlet path
a reservoir comprising a liquid aerosol-forming substrate; and
a heating element;
wherein the reservoir has an upper domain and a lower domain the upper domain and the lower domain being in fluid connection with each other, the lower domain defining an opening to the aerosol outlet path,
wherein the heating element comprises a lower part arranged at the opening of the lower domain and an upper part extending within the upper domain, and
wherein the heating element extends along the aerosol outlet path.

2. The consumable according to claim 1, wherein the upper part and the lower part of the heating element are integrally formed.

3. The consumable according to claim 2, wherein the upper part of the heating element is arranged within the volume of the upper domain enclosed by reservoir walls such that it is surrounded by the liquid aerosol-forming substrate.

4. The consumable according to claim 1, wherein
the lower part of the heating element is configured to wick the liquid aerosol-forming substrate.

5. The consumable according to claims 1, wherein the lower part of the heating element is configured to heat the liquid aerosol-forming substrate to a first temperature suitable for generating an aerosol.

6. The consumable according to claims 5, wherein the upper part of the heating element is configured to heat the liquid aerosol-forming substrate comprised in the upper domain of the reservoir to a second temperature not suitable for generating an aerosol.

7. The consumable according to claims 1, wherein
the surface area of the upper part of the heating element makes up at least 10% of the surface area of the heating element, and/or
the surface area of the lower part makes up less than 50% of the surface area of the heating element.

8. The consumable according to claims 1, wherein the lower part of the heating element is permeable to the liquid aerosol-forming substrate, and/or wherein at least a portion of the lower part of the heating element is perforated.

9. The consumable according claims 1, wherein at least 50% of the volume of the reservoir is arranged in the upper domain of the reservoir.

10. The consumable according to claims 1, wherein the lower part of the heating element is an active heater configured to be heated by direct or indirect interaction with an electrical current, and
wherein the upper part of the heating element is a passive heater configured to be heated by heat transferred from the lower part of the heating element.

11. The consumable according to claims 1, wherein the heating element is a susceptor element.

12. The consumable according claims 1, further comprising a wicking element in contact with and arranged for directly wicking the liquid aerosol-forming substrate from the opening of the lower domain of the reservoir to the heating element.

13. The consumable according to claims 1, wherein the upper domain of the reservoir is divided into a first part and a second part arranged on two opposing sides of the aerosol outlet path such that the two parts are not in direct fluid connection within the upper domain.

14. An aerosol generation device for use with a consumable according claims 1, the aerosol generation device comprising:
means for receiving the consumable and
means for supplying energy to the heating element, wherein the receiving means of the aerosol generation device is configured to receive at least the portion of the consumable which comprises the lower part of the heating element.

15. An aerosol generation system comprising:
an aerosol generation device; and
a consumable for use with the aerosol generation device, the consumable comprising:
an aerosol outlet path;
a reservoir comprising a liquid aerosol-forming substrate; and
a heating element;
wherein the reservoir has an upper domain and a lower domain, the upper domain and the lower domain being in fluid connection with each other, the lower domain defining an opening to the aerosol outlet path,
wherein the heating element comprises a lower part arranged at the opening of the lower domain and an upper part extending within the upper domain, and
wherein the heating element extends along the aerosol outlet path.
